(19) United States
(12) Patent Application Publication
(10) Pub. No.: US 2020/0056412 A1
(43) Pub. Date: Feb. 20, 2020

(54) FRAMELESS WINDOW REGULATOR WITH COMPOSITE RAILS

(71) Applicant: INTEVA PRODUCTS FRANCE SAS, Sully sur Loire (FR)

(72) Inventors: Gabriel Hazon, Sully Sur Loire (FR); Stephane Hemond, Sully Sur Loire (FR)

(21) Appl. No.: 16/540,677

(22) Filed: Aug. 14, 2019

Related U.S. Application Data
(60) Provisional application No. 62/718,593, filed on Aug. 14, 2018.

(51) Int. Cl. E05D 15/16; D06M 15/227; D06M 15/507; D06M 15/59; B29C 51/00; B29C 70/68

(52) U.S. Cl. CPC E05D 15/165; D06M 15/227; D06M 15/507; B29K 2101/12; B29C 51/002; B29C 70/68; D06M 15/59

(57) ABSTRACT

A window regulator includes a guide rail including a thermoformed composite. The thermoformed composite includes a thermoplastic composition and reinforcing fibers.

### CROSS REFERENCE TO RELATED APPLICATIONS

This application claims the benefit of U.S. Provisional Application No. 62/718,593, filed Aug. 14, 2019, which is incorporated by reference in its entirety herein.

### BACKGROUND

Actuation of windows, such as vehicle windows, often utilizes window regulator systems for controlling vertical movement. In one configuration, such window regulator systems include one or more window attachments each slidably engaging a vertically orientated guide rail. The window attachment also includes an attachment feature for attachment of the window to the window attachment and hence the vertically orientated guide rail. The window attachment is attached to a drive means, such as a cable, which is driven by a drum motor. In operation, as the drum motor rotates it engages the cable causing movement of the cable and window attachment along the guide rails. This in turn causes movement of the window in a direction parallel to the guide rail, e.g., vertical movement.

### BRIEF DESCRIPTION

Disclosed herein is a window regulator that includes a guide rail including a thermoformed composite. The thermoformed composite includes a thermoplastic composition and reinforcing fibers.

In addition to one or more of the features described above, or as an alternative to any of the foregoing embodiments, the reinforcing fibers may comprise glass fiber, carbon fiber, aramid fiber, bio sourced fibers, and combinations thereof.

In addition to one or more of the features described above, or as an alternative to any of the foregoing embodiments, the reinforcing fibers may be continuous.

In addition to one or more of the features described above, or as an alternative to any of the foregoing embodiments, the reinforcing fibers may be woven.

In addition to one or more of the features described above, or as an alternative to any of the foregoing embodiments, the reinforcing fibers may be non-woven.

In addition to one or more of the features described above, or as an alternative to any of the foregoing embodiments, the thermoplastic composition comprises a polyamide, a polyester, a polyethylene, a polypropylene, or a combination thereof.

In addition to one or more of the features described above, or as an alternative to any of the foregoing embodiments, the thermoformed composite comprises a bio sourced thermoplastic, a bio sourced reinforced fiber, or both.

In addition to one or more of the features described above, or as an alternative to any of the foregoing embodiments, the thermoplastic composition further comprises a pigment, dye, a flame retardant, or combination thereof.

In addition to one or more of the features described above, or as an alternative to any of the foregoing embodiments, the guide rail may further comprise an overmolded technical shape. The technical shape may be a rib.

Also disclosed herein is a method of making the above described window regulator. The method includes thermoforming a thermoformable composite to form a guide rail. The thermoformable composite includes a thermoplastic composition and reinforcing fibers.

In addition to one or more of the features described above, or as an alternative to any of the foregoing embodiments, the reinforcing fibers comprise glass fiber, carbon fiber, aramid fiber, bio sourced fibers, and combinations thereof.

In addition to one or more of the features described above, or as an alternative to any of the foregoing embodiments, the reinforcing fibers are continuous.

In addition to one or more of the features described above, or as an alternative to any of the foregoing embodiments, the reinforcing fibers are woven.

In addition to one or more of the features described above, or as an alternative to any of the foregoing embodiments, the reinforcing fibers are non-woven.

In addition to one or more of the features described above, or as an alternative to any of the foregoing embodiments, the thermoplastic composition comprises a polyamide, a polyester, a polyethylene, a polypropylene, or a combination thereof.

In addition to one or more of the features described above, or as an alternative to any of the foregoing embodiments, the thermoplastic composition further comprises a pigment, dye, a flame retardant, or combination thereof.

In addition to one or more of the features described above, or as an alternative to any of the foregoing embodiments, the method may further comprise overmolding the guide rail to form a technical shape. The technical shape may comprise a rib.

### BRIEF DESCRIPTION OF THE DRAWINGS

The following descriptions should not be considered limiting in any way. With reference to the accompanying drawings, like elements are numbered alike:

FIG. 1 illustrates a schematic view of a vehicle door including a window regulator device.

### DETAILED DESCRIPTION

A detailed description of one or more embodiments of the disclosed apparatus and method are presented herein by way of exemplification and not limitation with reference to the Figures.

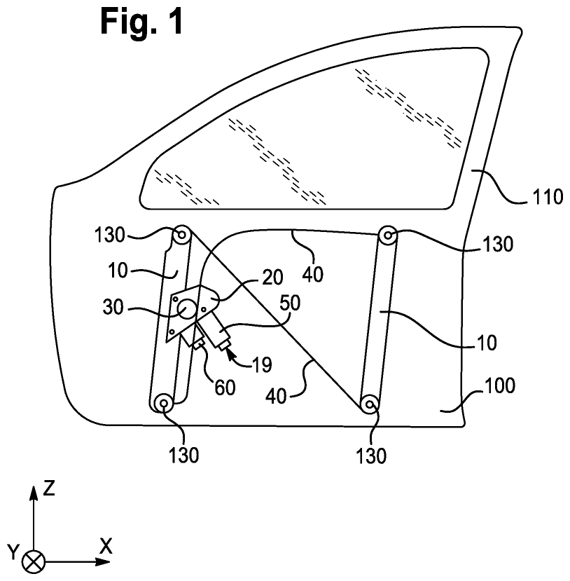

FIG. 1 shows a schematic view of a motor vehicle door including a window regulator device 19 according to the invention. FIG. 1 is a view in the plane (X, Z) of a body of a vehicle. FIG. 1 shows a door shell 100 with a window frame 110. A window is adapted to slide between a closed position in which the window fills the window frame 110 and an open position in which the window is completely housed in the door shell 100. In some embodiments there is no window frame and the window fills the entire open space above the door shell. The window regulator device 19 drives the window between the closed position and the open position. Sliders attached to the window slide on guide rails 10. Depending on the model of the vehicle, the door can include two guide rails 10 equipped with sliders or a single guide rail 10 together with a window guide. Two guide rails 10 are illustrated in FIG. 1, although this embodiment does not limit the invention.

In operation, activation of the window regulator system is initiated through rotation of drive motor 50. The drive motor is engaged with cable 40, winds and unwinds cable 40 on cable drum 30, and moves the cable 40 along pulleys 130, thus moving sliders along the guide rails 10. Generally, an electronic unit 60 is associated with the drive motor 50 to control, among other things, the speed and direction of rotations of the drive motor 50. As the cable is attached to window attachments installed on the sliders movement of the cable causes movement of the window through the window attachment. The cable drum 30 can also be driven by a crank.

Guide rails window systems without window frames have typically been made from stamped metal such as stamped steel. Steel is usually used for the guide rail in this type of window regulator mechanism as the guide rail needs the strength of the steel to properly retain the glass in the required location. Stamped metal guide rails are heavy and increase the overall weight of the door and hence the vehicle. Guide rails in window systems with a frame have typically been made from steel, aluminum or injection molded thermoplastic. Reductions in weight are desirable for environmental and a variety of economic and design reasons. Stiffness is also a desirable characteristic to maintain the position of the glass in the window system, particularly in window systems without window frames. Described herein is a guide rail formed from a thermoformable composite which has similar strength and stiffness to a steel guide rail but significantly less weight than a stamped steel or aluminum guide rails. An injection molded thermoplastic guide rail has similar weight to the thermoformable composite guide rail but has insufficient stiffness and cannot be used on window systems without window frames.

The thermoformable composite comprises a thermoplastic composition and a reinforcing fiber. The thermoplastic composition may comprise a polyamide, a polyester, a polyethylene, a polypropylene, or a combination thereof. Exemplary polyesters include polybutylene terephthalate. It is contemplated that some of these polymers may be partially or completely biosourced. The thermoplastic composition may further comprise a pigment, dye or other additive such as a flame retardant.

Exemplary reinforcing fibers include glass fiber, carbon fiber, aramid fiber, bio sourced fibers, and combinations thereof. The reinforcing fiber may be continuous. The reinforcing fiber may be woven or non-woven. The fibers may be oriented in a direction that will provide better strength to the guide rail. In the case where several layers are used, the orientation of each layer and the fibers may be chosen to provide the better strength to the guide rail, depending on the load applied on the part. It is contemplated that when multiple layers are used the fibers in the layers may be oriented in differing directions. For example, the first and third layers may have fibers oriented in the same direction and the second layer has fibers oriented in a different direction. In embodiments having two layers the fiber orientation may be the same or different in each of the two layers. It is also contemplated that in embodiments having more than two layers the fibers in each layer may be oriented in a different direction.

Exemplary thermoformable materials are commercially available from LANXESS under the tradename TEPEX, from DuPont under the tradename VIZILON and from Celanese under the tradename CELSTRAN CFR-TP.

In an exemplary process the thermoformable composite is sized to provide a thermoformable blank. The thermoformable blank may have an area which is larger than the final guide rail. The thermoformable blank is placed in a mold and subjected to sufficient heat and pressure to thermoform the composite into the desired shape for the guide rail. If necessary, the thermoformable blank is heated prior to being placed in the mold. The thermoformable blank can also be heated in the mold prior to forming. If necessary, after forming the guide rail, excess material may be trimmed or the guide rail may be subjected to other finishing operations prior to being assembled with other components into a window regulator.

Another advantage of the thermoformable composite material is that it can be overmolded using the same polymer or a compatible polymer. This allows integration of one or more technical shape(s) on the thermoformable composite which is not feasible through the stamping. Technical shape(s) include ribs, for example, which will help to increase stiffness of the thermoformable composite part. Technical shape(s) can be also for door fixation, bossing for screwing, mechanical upper or lower stop of the window holder that slides along the guide rail, cable sleeve stop, cable tensioner interface, drum cover, cable pulley shaft, cable deflection ramp, clip for sleeve and/or wiring harness, loudspeaker attachment, or any combination of the foregoing. The foregoing list is merely exemplary and is not limiting.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A window regulator comprising a guide rail, wherein the guiderail comprises a thermoformed composite and the thermoformed composite comprises a thermoplastic composition and reinforcing fibers.

2. The window regulator of claim 1, wherein the reinforcing fibers comprise glass fiber, carbon fiber, aramid fiber, bio sourced fibers, and combinations thereof.

3. The window regulator of claim 1, wherein the reinforcing fibers are continuous.

4. The window regulator of claim 1, wherein the reinforcing fibers are woven.

5. The window regulator of claim 1, wherein the reinforcing fibers are non-woven.

6. The window regulator of claim 1, wherein the thermoplastic composition comprises a polyamide, a polyester, a polyethylene, a polypropylene, or a combination thereof.

7. The window regulator of claim 1, wherein the thermoformed composite comprises a bio sourced thermoplastic, a bio sourced reinforced fiber, or both.

8. The window regulator of claim 1, wherein the thermoplastic composition further comprises a pigment, dye, a flame retardant, or combination thereof.

9. The window regulator of claim 1, further comprising an overmolded technical shape.

10. The window regulator of claim 9, wherein the technical shape comprises a rib.

11. A method of making a window regulator comprising thermoforming a thermoformable composite to form a guide rail.

12. The method of claim 11, wherein the thermoformable composite comprises a thermoplastic composition and reinforcing fibers.

13. The method of claim 12, wherein the reinforcing fibers comprise glass fiber, carbon fiber, aramid fiber, bio sourced fibers, and combinations thereof.

14. The method of claim 12, wherein the reinforcing fibers are continuous.

15. The method of claim 12, wherein the reinforcing fibers are woven.

16. The method of claim 12, wherein the reinforcing fibers are non-woven.

17. The method of claim 12, wherein the thermoplastic composition comprises a polyamide, a polyester, a polyethylene, a polypropylene, or a combination thereof.

18. The method of claim 12, wherein the thermoplastic composition further comprises a pigment, dye, a flame retardant, or combination thereof.

19. The method of claim 11, further comprising overmolding the guide rail to form a technical shape.

20. The method of claim 19, wherein the technical shape comprises a rib.
